(19) United States
(12) Patent Application Publication
(10) Pub. No.: US 2016/0316714 A1
(43) Pub. Date: Nov. 3, 2016

(54) Animal Safety Harness for Use in Vehicles

(71) Applicant: Thomas J. Frick, Brick, NJ (US)

(72) Inventor: Thomas J. Frick, Brick, NJ (US)

(21) Appl. No.: 14/700,226

(22) Filed: Apr. 30, 2015

(51) Int. Cl. A01K 1/02; B60R 22/10

(52) U.S. Cl. CPC A01K 1/0272; A01K 1/0263; B60R 22/10

(57) ABSTRACT

An animal safety harness system is disclosed. The animal safety harness comprises a series of adjustable straps to fit safely and comfortably around the animal. The animal safety harness also includes an additional set of straps which are used in connection with existing vehicle seat belt connectors to safely restrain the animal in the vehicle.

### BACKGROUND OF THE INVENTION

The present invention is directed to the field of safety harnesses for animals. In particular, it is directed to the field of safety harnesses that can be utilized to safely restrain a small animal such as a dog when traveling in a vehicle.

There are many differing types of harnesses for small animals such as dogs. However, none of those harnesses can be used to easily connect to vehicle seat belts. The present invention cures this problem by providing a safety harness with a strap that can be buckled into a seat belt latch in the vehicle. The present invention can be used as a normal harness in conjunction with a leash but is also adapted to allow the animal to be properly and safely restrained in a seat in the vehicle

### BRIEF DESCRIPTION OF THE DRAWINGS

FIG. 1 is an isometric view illustrating the use of the present invention with a dog.

FIG. 2 is a front elevation view of the components of the present invention.

FIG. 3 is a rear elevation view of the components of the present invention.

FIG. 4 is a side elevation view of the components of the present invention.

FIG. 5 is a side elevation view of the components of the present invention.

FIG. 6 is a top elevation view of the present invention.

FIG. 7 is a bottom elevation view of the present invention.

### SUMMARY OF THE INVENTION

An animal safety harness for use in safely restraining an animal in a vehicle comprising a plurality of generally circular straps that are generally aligned parallel to each other, a plurality of first linear straps that are fixed to the plurality of generally circular straps and join the plurality of generally circular straps to each other and a seatbelt buckle attachment harness system comprising a plurality of second linear straps connected to a seatbelt insertion tongue mechanism that engages with the existing seatbelt connector in the vehicle.

### DETAILED DESCRIPTION OF THE INVENTION

The present invention will now be described in connection with the appended drawings. Those of ordinary skill in the art will recognize that this disclosure is merely one embodiment of the present invention and obvious modifications may be made thereto without departing from the scope of the present invention.

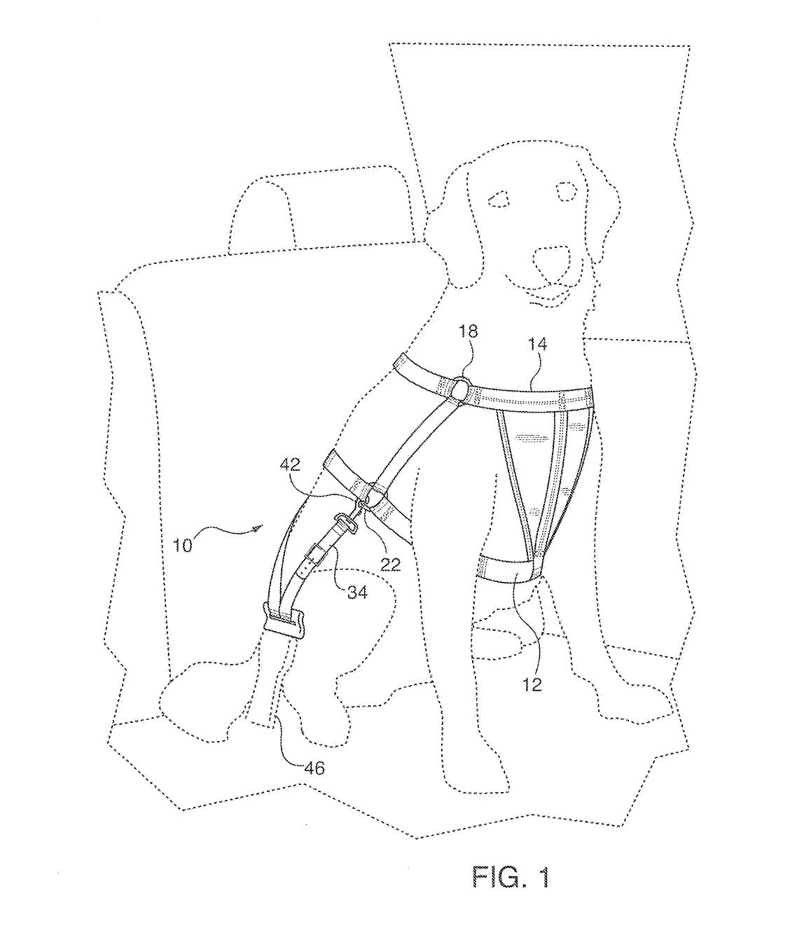

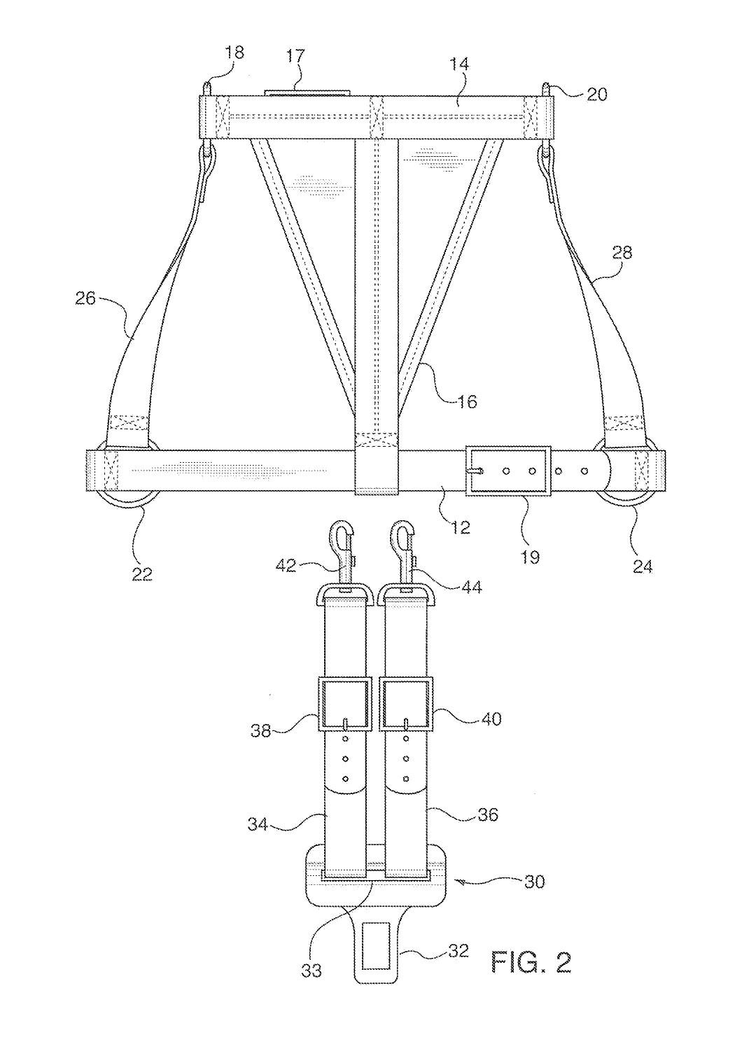

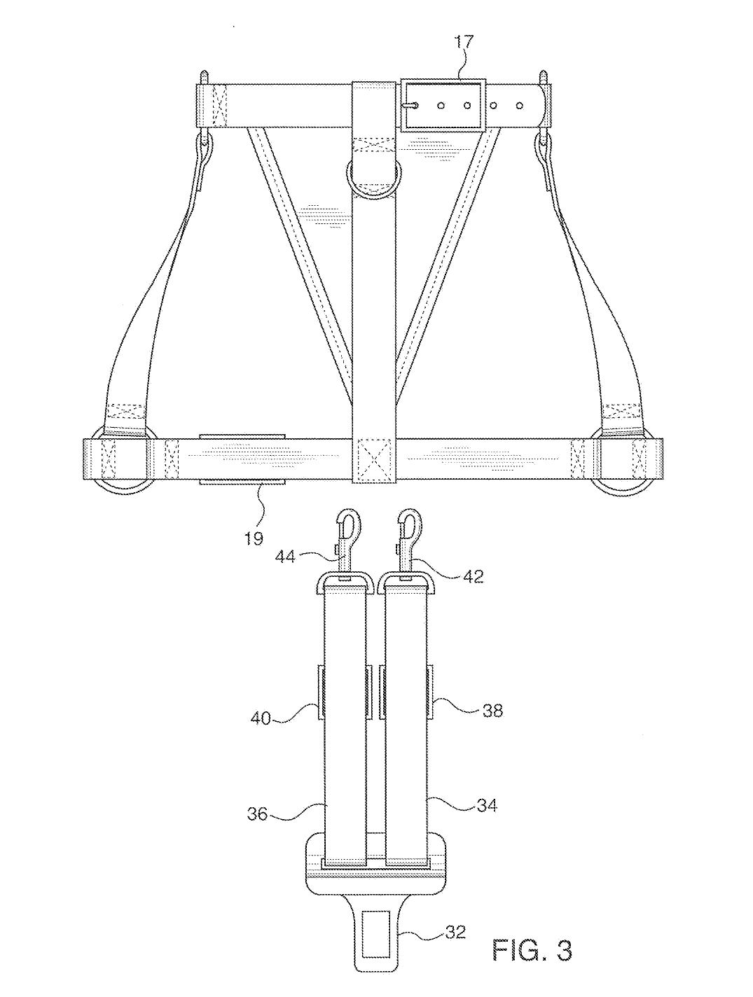

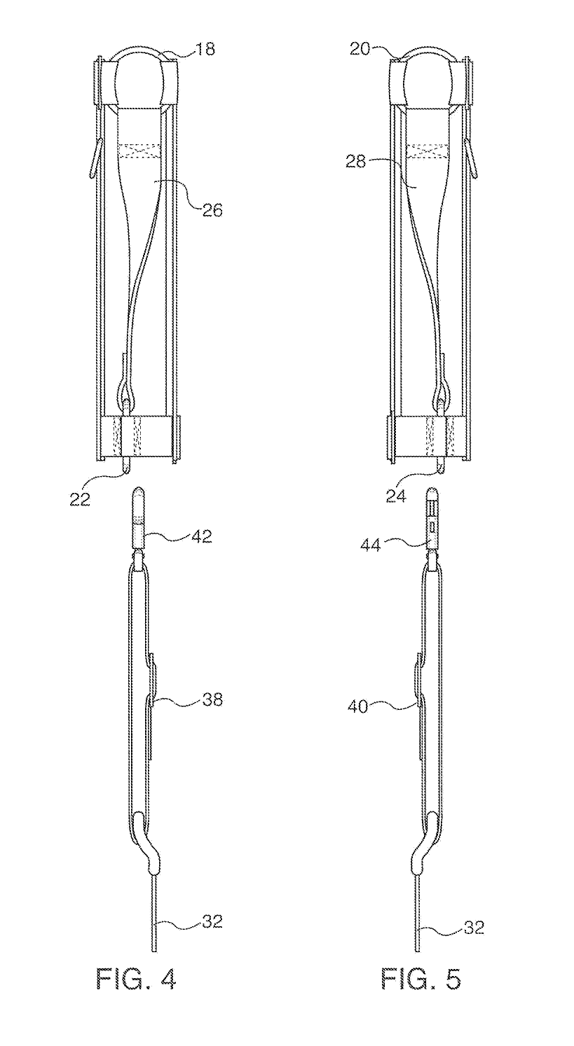

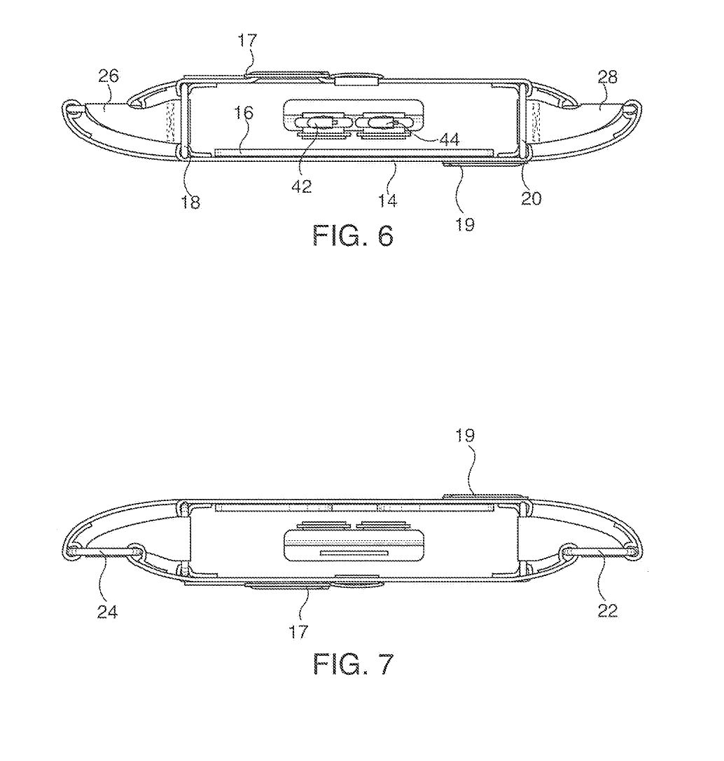

The animal safety harness 10 of the present invention is illustrated in the drawings. FIG. 1 illustrates the use of the harness 10 on a dog. FIG. 1 shows how the harness 10 is used to restrain an animal riding in the passenger seat of a vehicle.

The harness 10 comprises two generally circular straps 12 and 14. The circular straps 12 and 14 are connected by means of a plurality of linear straps 16. The plurality of linear straps 16 are fixed to the circular straps 12 and 14 in this embodiment by being sewn thereto. The generally circular straps 12 and 14 are aligned generally parallel to each other.

The generally circular straps 12 and 14 are formed in this embodiment by joining several portions with two circular metal loops 18, 20, 22 and 24 respectively. Linear strap 26 is fixed to circular loops 18 and 22. Linear strap 28 is fixed to circular loops 20 and 24.

The generally circular straps 12 and 14 each further comprise conventional buckles 16 and 17 respectively. The buckles 16 and 17 are used to adjust the length of the circular straps 12 and 14 to create a comfortable and secure fit on the animal.

The animal safety harness 10 further comprises a seatbelt buckle attachment harness system 30. The harness system 30 comprises a conventional seatbelt insertion tongue mechanism 32. Two adjustable restraining straps 34 and 36 are fixed to a slot 33 in the insertion tongue mechanism 32. The straps 34 and 36 are adjustable in length by means of buckles 38 and 40 respectively. The straps 34 and 36 each comprise a fastener 42 and 44 respectively on the end opposite to the insertion tongue mechanism 32. The fasteners 42 and 44 are configured to reversibly connect the straps 34 and 36 to the circular metal rings 22 and 24 on the circular strap 12.

In use, the animal will be placed in the harness 10. The length of the circular straps 12 and 14 will be adjusted via the respective buckles 16 and 17 to comfortably and securely fit the animal. The harness system 30 is attached by means of fasteners 42 and 44 to the circular metal loops 22 and 24. The animal is placed in the vehicle seat and the length of straps 34 and 36 are adjusted so that the buckle 32 engages the existing seatbelt connector 46 in the vehicle. The animal is then safely restrained.

What is claimed is:

1) An animal safety harness for use in safely restraining an animal in a vehicle comprising:
a. A plurality of generally circular straps that are generally aligned parallel to each other;
b. A plurality of first linear straps that are fixed to the plurality of generally circular straps and join the plurality of generally circular straps to each other; and
c. A seatbelt buckle attachment harness system comprising a plurality of second linear straps connected to a seatbelt insertion tongue mechanism that engages with the existing seatbelt connector in the vehicle.

2) The animal safety harness of claim 1 wherein the plurality of generally circular straps each comprising a buckle for adjusting the length thereof to comfortably fit the animal.

3) The animal safety harness of claim 2 wherein the plurality of second linear straps comprise a buckle for adjusting the length thereof to comfortably fit the animal.
